(19) United States
(12) Patent Application Publication
(10) Pub. No.: US 2008/0224346 A1
(43) Pub. Date: Sep. 18, 2008

(54) Method and Apparatus for Producing Plastic Film

(75) Inventors: Kari Kirjavainen, Tampere (FI); Teuvo Arpiainen, Nokia (FI); Markku Vilkki, Lahti (FI); Hannu Lehtola, Karppala (FI)

Correspondence Address: BROOKS KUSHMAN P.C., 1000 TOWN CENTER, TWENTY-SECOND FLOOR, SOUTHFIELD, MI, 48075, US

(73) Assignee: CONENOR OY, Tampere (FI)

(21) Appl. No.: 12/067,361

(22) PCT Filed: Jun. 5, 2006
(86) PCT No.: PCT/FI06/50236

§ 371 Date: Mar. 19, 2008

(30) Foreign Application Priority Data
Sep. 19, 2005 (FI) 20055500

(51) Int. Cl. B29C 47/00; D01D 5/12

(52) U.S. Cl. 264/210.1; 425/325

(57) ABSTRACT

A film (5) is extruded from plastic material by means of an extruder. Material is mixed into the plastic (5a) of the plastic film (5) before the extrusion so that cavitation bubbles are formed in the material particles mixed into the plastic (5a) when the plastic film is stretched. The film (5) is orientated by stretching. After the extrusion the plastic film (5) is cooled slowly below the crystallization point of the plastic material before the orientation.

### BACKGROUND OF THE INVENTION

The invention relates to a method for producing a plastic film, the method comprising extruding a plastic film, cooling the plastic film, mixing material into the plastic of the plastic film before the extrusion, the material causing cavitation bubbles in the plastic film to be stretched, and orientating the plastic film by stretching after the cooling.

The invention also relates to an apparatus for producing a plastic film, the apparatus comprising an extruder, a cooling device and at least one orientation device for orientating the extruded film.

### BRIEF DESCRIPTION OF THE INVENTION

Making a plastic film by extruding, cooling and then orientating it is known e.g. from U.S. Pat. Nos. 3,244,781 and 3,891,374. It is, however, difficult to make thin and, in particular, thin low-density films using these solutions.

EP publication 0,182,764 discloses a thin polypropylene film which contains wide and flat disc-like bubbles, which are about 80 micrometers in length and 50 micrometers in width. The film is produced by extruding material which has been foamed chemically or by means of gas and by orientating the extruded material biaxially thereafter. The result is a multipurpose plastic film with very versatile properties. However, the foaming degree of the plastic film is less than 50%, which is why the properties of the film are not good enough for all purposes.

U.S. Pat. No. 3,634,564 discloses orientation of a foamed film to obtain a fiberized film. The foamed film is formed by mixing a foam forming substance into the plastic material. The foam forming substance is extruded, which yields a foamed film, which is stretched. The bubbles of the film obtained are, however, rather large.

U.S. Pat. No. 4,814,124 discloses a film made of polyolefin and a filler which is stretched to obtain a gas permeable porous film. However, the foaming degree of such a film is not sufficiently good, nor are the mechanical properties of such a porous film sufficiently good for acoustic applications, for example.

Publications WO 99/51419 and WO 01/19596 disclose a method and apparatus for making a plastic film, wherein a film is extruded from plastic material by an extruder, the film is cooled and then orientated by stretching. Material is mixed into the plastic so that when the plastic film is stretched, cavitation bubbles are formed in the material particles mixed into the plastic. The foaming degree of the film is increased in such a manner that after or during the orientation, gas is arranged to act on the plastic film under high pressure so that the gas diffuses in the cavitation bubbles.

The object of the present invention is to provide a very good and thin foamed plastic film and a simple and reliable method and apparatus for making such a plastic film.

The method of the invention is characterized in that after the extrusion the plastic film is cooled slowly below the crystallization point.

The apparatus of the invention is characterized in that the apparatus comprises a control unit arranged to control the cooling device in such a manner that after the extrusion the plastic film cools slowly below the crystallization point.

The essential idea of the invention is that a film is extruded from plastic material by means of an extruder and material has been mixed into the plastic so that when the plastic is stretched cavitation bubbles are formed in the material particles mixed into the plastic. The film is orientated by stretching. After the extrusion the plastic film is cooled before the orientation. It is essential that the cooling of the plastic film is slow. The purpose of slow cooling is to increase the proportion of cavitation bubbles in the film, i.e. to provide as high a foaming degree as possible and as low a plastic film density as possible.

An advantage of the invention is that very thin films with a high foaming degree can be provided in a relatively simple manner. An advantage of the high foaming degree is that the electric and mechanical properties of the film are very good.

### BRIEF DESCRIPTION OF THE FIGURES

The invention will be described in greater detail in the accompanying drawings, in which

FIG. 1 is a schematic cross-sectional side view of an apparatus for producing a plastic film,

FIG. 2 is a partially cross-sectional top view of the apparatus illustrated in FIG. 1,

FIG. 3 is a cross-sectional view of a detail of the apparatus illustrated in FIG. 1 along line A-A,

FIG. 4 is a cross-sectional view of a detail of the apparatus illustrated in FIG. 1 along line B-B,

FIG. 5 is a cross-sectional view of a detail of the apparatus illustrated in FIG. 1 along line C-C,

FIG. 6 is a schematic cross-sectional top view of an extruder used in the apparatus for producing a plastic film,

FIG. 7 is a schematic side view of a relaxation unit, and

FIGS. 8a and 8b schematically illustrate the effect of relaxation on the bubble form.

### DETAILED DESCRIPTION OF EMBODIMENTS OF THE INVENTION

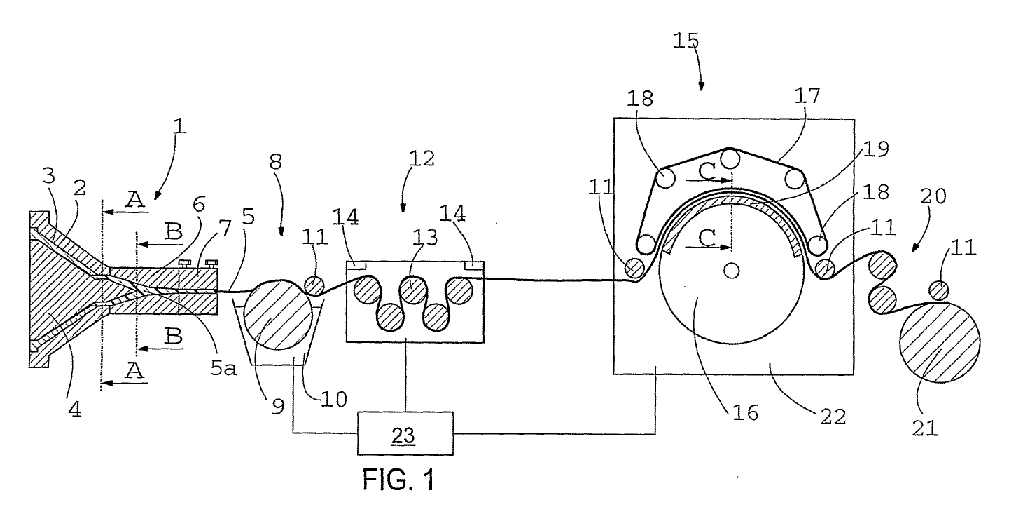

FIG. 1 is a side view of an apparatus for producing a plastic film. The apparatus comprises an extruder 1. The extruder 1 may be for example conical so that it comprises a cone-shaped rotor 2, outside of which there is an outer stator 3 whose surface at least on the rotor 2 side is cone-shaped, and inside of which there is an inner stator 4 whose surface at least on the rotor 2 side is cone-shaped. When the rotor 2 rotates, it extrudes material which is between the rotor 2 and the stators 3 and 4 from the extruder 1 in a manner known per se. For the sake of clarity the attached figures do not illustrate e.g. the rotating devices of the rotor or the feeding devices for feeding the material to be extruded into the extruder 1. The extruder 1 may comprise more than one rotor 2 and more than two stators 3 and 4. In that case the extruder 1 can be used for extruding multilayer products. The solution with one rotor 2 and two stators 3 and 4 can be used for making two-layer products. The end portion of the inner stator 4 is wide and tapers in the vertical direction so that together with a nozzle 6 it forms a relatively flat and wide gap through which plastic 5a is extruded. After the nozzle 6 there is a calibration piece 7 whose nuts are used for adjusting the height of the gap, which allows to define the thickness of the plastic film 5 to be obtained from the extruder 1.

After the extruder 1 the plastic film 5 is cooled by a cooling device 8. The cooling device 8 may comprise e.g. a cooling roll 9, which is arranged in a cooling tank 10 containing a cooling medium, e.g. water. The plastic film 5 is arranged to be pressed against the cooling roll 9. The apparatus according to FIG. 1 uses auxiliary rolls 11 for guiding the plastic film 5 at several points.

After cooling the plastic film 5 is guided to a machine direction orientation device 12. The machine direction orientation device 12 comprises orientation rolls 13 whose velocities are adjusted so that they can be used for stretching the plastic film 5 and thus for orientation in the machine direction. If desired, the velocity of each orientation roll 13 can be adjusted separately. The machine direction orientation device 12 may also comprise heating means 14, such as radiation heaters, for heating the plastic film 5 in a manner known per se. The orientation rolls 13 can also be used for heating the plastic film 5 by supplying a heating medium, such as heated oil, to the orientation rolls 13 so that the orientation rolls 13 become warm. If desired, the temperature of each orientation roll 13 can be adjusted separately.

Suitable material, such as calcium carbonate particles, is mixed into the plastic 5a of the plastic film 5, and due to the influence of the particles the joint surfaces of the plastic molecules and the mixed material are torn during orientation, and thus cavitation bubbles are formed.

After the machine direction orientation device 12 the plastic film 5 is supplied to a cross-direction orientation device 15. In the cross-direction orientation device 15 the plastic film 5 is stretched in the cross-direction, i.e. orientation is performed in the direction substantially perpendicular to the direction of the orientation performed in the machine direction orientation device 12. Due to cross-direction stretching the bubbles can grow sideways and in the vertical direction in the cross-direction orientation device 15. The cross-direction orientation device 15 comprises two orientation wheels 16, and an orientation band 17 is arranged against both of the wheels. The orientation band 17 is an endless band which is guided by means of band guide rolls 18. The edges of the plastic film 5 are arranged between the orientation wheel 16 and the orientation band 17. Thus, the orientation band 17 presses the edges of the plastic film 5 firmly and evenly between the orientation band 17 and the orientation wheel 16 substantially along the whole travel of the cross-direction orientation device 15, in which case the film is not subjected to point-like pressure stress or tensile strain, and thus the plastic film stretches sideways without tearing. In FIG. 1 the plastic film 5, orientation wheel 16 and orientation band 17 are illustrated at a distance from one another for the sake of clarity, but in reality these parts are pressed firmly against one another. The orientation wheels 16 and the orientation bands 17, respectively, are arranged so that in the direction of travel of the plastic film 5 they are further away from one another at the end than at the beginning, as is illustrated in FIG. 2, and thus the cross-direction orientation device 15 stretches and simultaneously orientates the plastic film 5 in the cross-direction. The deviation of the angle between the orientation wheels 16 and the orientation bands 17 from the machine direction can be adjusted to regulate the desired degree of cross-direction stretching. One or more band guide rolls 18 can be arranged to be rotated by the rotating means. Since the bands 17 are firmly pressed against the orientation wheels 16, the orientation wheels 16 do not necessarily need rotating means but may rotate freely. For the sake of clarity the enclosed figures do not illustrate rotating means or other actuators of the apparatus. A curved support plate 21, which has substantially the same shape as the circumference of the orientation wheels 16, is arranged between the orientation wheels 16 to support the plastic film 5.

The cross-direction orientation device 15 can be placed in a casing 22 of its own. If desired, the casing 22 can be provided with heaters known per se, such as radiation heaters, to heat the plastic film 5.

After the cross-direction orientation device 15 the plastic film 5 is led to a relaxation unit 20. In the relaxation unit 20 the plastic film 5 is relaxed, and thus the plastic film shrinks a bit in a manner known per se. Finally, the plastic film 5 is wound on a reel 21.

FIG. 2 is a cross-sectional top view of the apparatus of the invention at the extruder 1. For the sake of clarity FIG. 2 does not illustrate the plastic film 5 or the support structures of the apparatus onto which the rolls, reels and plates of the apparatus are attached, for instance.

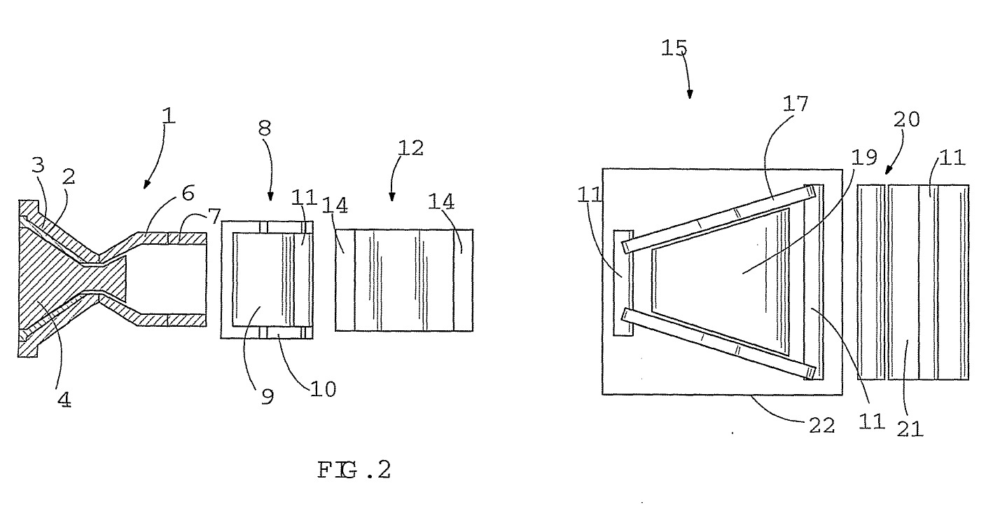

FIG. 3 is a cross-sectional view of a detail of the extruder 1 along line A-A of FIG. 1. Here both the outer stator and the inner stator 4 are round in cross-section. Thus the plastic material 5a is also in an annular feeding channel.

FIG. 4 is a cross-sectional view of a detail of the extruder 1 along line B-B of FIG. 1. Here we see the wide tip of the inner stator 4 and the shape of the nozzle 6 which extrude the plastic 5a into the wide and flat gap, and thus a flat plastic film 5 is formed from the plastic 5a.

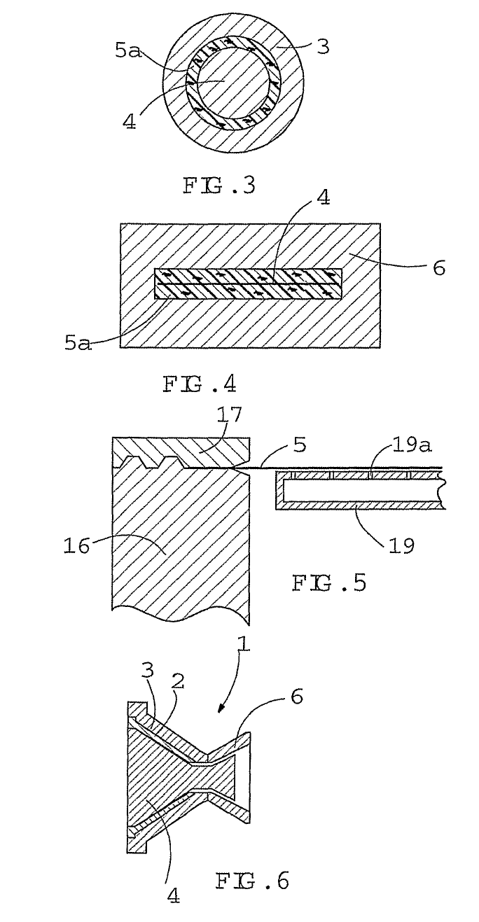

FIG. 5 is a cross-sectional view of a detail of the cross-direction orientation device 15 along line C-C of FIG. 1. It is seen in FIG. 5 how the orientation wheel and the orientation band are pushed against each other and press the plastic film 5 between each other. The support plate 19 may be formed in such a manner that a surface thereof which is against the plastic film 5 is heated e.g. by providing it with a heating resistor, and thus the plastic film 5 slides along the sliding surface in question very easily. Furthermore, propellant, such as air, can be blown from inside the support plate 19 through the gaps 19a, in which case the propellant flowing through the gaps 19a provides a sliding bearing between the support plate 19 and the plastic film 5. The gas in question may be heated, if desired, and thus the sliding surface of the support plate 19 and the plastic film 5 are heated with the propellant flowing through the gaps 19a.

FIG. 6 illustrates an extruder 1 used in the apparatus according to the invention. The nozzle 6 of the extruder 1 widens up to the end portion of the extruder, i.e. up to the point where the plastic film 5 exits from the extruder 1. In the nozzle 6 of the extruder 1 the plastic 5a is thus all the time subjected to cross-direction orientation in addition to longitudinal orientation, which makes it considerably easier to orientate the plastic film 5 in the cross-direction at a later processing stage.

Before the extrusion calcium carbonate particles have been mixed into the plastic 5a. Instead of calcium carbonate particles some other material may also be mixed into the plastic 5a, the material causing the joint surface of the plastic molecules and the material mixed into the plastic 5a to tear when the plastic film 5 is stretched so that cavitation bubbles are formed at the tearing points. Such a material is referred to as nucleating agent. Thus some oily substance, such as silicone oil or paraffin oil, can be mixed into the plastic 5a.The particles mixed into the plastic 5a may cause spot-like asymmetry e.g. in the electric field in the plastic 5a, whereas the oily substance mixed into the plastic does not substantially worsen the electric properties of the plastic. It is also possible to mix a substance having a melting point lower than the orientation temperature of the plastic 5a, such as paraffin, into the plastic 5a, in which case the substance melts when the plastic 5a is orientated. Also, a plastic with no adhesion to the plastic forming the plastic film may be used as a nucleating agent. For example, a nucleating agent such as polyester may be mixed into polypropylene PP. The plastic 5a may be made e.g. from polyamide PA, polyester or a polyolefin, such as polypropylene PP or polyethylene PE, or some other suitable plastic material.

The apparatus further comprises a control unit 23. The control unit 23 controls, for instance, the cooling temperature of the cooling device 8 and the heating devices of the machine direction orientation device 12 and of the cross-direction orientation device 15. Thus the control device 23 may be used for adjusting the cooling rate of the plastic film and the temperatures at which the plastic film is orientated.

In prior art solutions, the extruded plastic film is cooled as quickly as possible. The purpose is to make the cooling roll as cold as possible, whereby its temperature is 20° C., for example. Solutions are known, in which the temperature of the cooling roll is even below 0° C. In the present solution, the plastic film is, surprisingly, cooled very slowly after the extrusion. For instance, a polypropylene film is cooled at a relatively high temperature by using e.g. a cooling roll whose temperature is about 60° C. The purpose is to perform the cooling at a temperature lower than the melting temperature of the plastic but, simultaneously, at a temperature that is as high as possible. However, the cooling occurs at a temperature lower than the crystallization temperature. The crystallization temperature is a temperature at which there is a peak in the curve illustrating the heat energy transfer when the heat energy transferred by the molten plastic material is measured during the cooling of the plastic material. The melting temperature of polypropylene PP, for instance, is 167° C., and the crystallization temperature thereof about 90 to 120° C. The quicker the cooling, the lower the crystallization temperature is. The cooling may be performed e.g. at a temperature higher than 130° C. below the melting temperature of the plastic material. Preferably the cooling occurs at a temperature higher than 100° C. below the melting temperature of the plastic material.

It has surprisingly been noted that the proportion of cavitation bubble in the plastic film is bigger in slow cooling than in quick cooling. For instance, a plastic film whose proportion of air bubbles is over 70% may be produced, in which case the density of the plastic film is below 0,3 g/cm³. The reason for this is supposed to be the fact that during slow cooling, the crystallization of the plastic film can be slowed down, and thus large crystals are provided in the plastic film. The crystals are formed around the nucleating agent particles. Due to slow cooling, the crystal structure of the plastic material consists of large crystals. During the orientation of the plastic material, a cavitation bubble is formed relatively easily in a large crystal, which means that a large number of cavitation bubbles are produced. Thus the proportion of cavitation bubbles in the plastic material is quite high. The above-described solution thus functions particularly well when a crystalline plastic, such as polyester, polyamide PA or a polyolefin, e.g. polyethylene or polypropylene PP, is used as a material for the plastic film.

To cool down the plastic film sufficiently cooling has to last long enough. When e.g. polypropylene is cooled by a cooling device whose temperature is 60° C., one point is cooled about 6 seconds, for instance. It is reasonable to provide a sufficiently long cooling zone so that the velocity of the production line does not become too low. If the production rate of the plastic film line is, for instance, 10 m/min, the plastic film can be cooled at a distance of one metre, for example. The cooling device may be made sufficiently large, or there may be several cooling devices and cooling rolls one after another. Preferably the cooling of the plastic film lasts at least 5 seconds. Furthermore, the plastic film is preferably cooled less than 100° C. during this time. Thus the temperature of the plastic film is preferably reduced less than 30° C. in one second.

Most preferably the cooling is performed at normal air pressure. Thus the process is well manageable and the apparatus is simple.

In previously known prior art solutions, longitudinal orientation is performed at a fairly high temperature. For instance, when polypropylene is used, the orientation temperature in the longitudinal orientation is typically about 145° C. Surprisingly it has been noted that in terms of foaming degree very good results are achieved when the longitudinal orientation is implemented at a temperature lower than before. For instance, when polypropylene is used, the orientation temperature is about 137° C. Thus, when e.g. polypropylene PP is preferably used, the orientation temperature during the longitudinal orientation is lower than 25° C. below the melting temperature.

In previously known prior art solutions, the orientation temperature in cross-direction orientation is also relatively high. For example, when polypropylene is used, the orientation temperature has typically been about 155° C. Surprisingly it has been noted that the cross-direction orientation should also be performed at a lower temperature. For example, when a polypropylene film is orientated, the orientation temperature should be e.g. about 140° C. Thus, when e.g. polypropylene PP is used, the cross-direction orientation should preferably be performed at a temperature lower than 15° C. below the melting temperature.

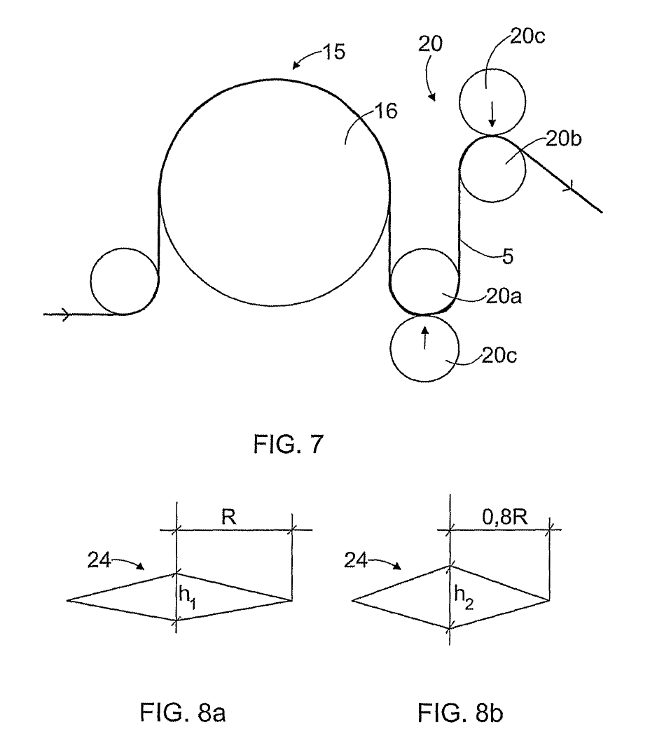

FIG. 7 shows a relaxation unit 20. The relaxation unit 20 comprises a first relaxation roll 20a, a second relaxation roll 20b and support rolls 20c. It is preferable to relax the plastic film 5 to a great extent, e.g. more than 10% or even more than 20%, both in the longitudinal direction and in the cross direction after the cross-direction orientation device 15. In this case, the walls of the cavitation bubbles 24 formed in the film 5 shorten in both directions, and as the amount of gas or air in the bubbles 24 remains constant, the bubbles 24 become higher. This improves the compression strength and bending stiffness of the film 5 substantially, because the bubbles 24 which were very flat earlier have now become more symmetrical.

Relaxation is performed by heating the film 5 close to the melting point by means of the first relaxation roll 20a. The film 5 shrinks in the cross direction during a free draw between the first relaxation roll 20a and the second relaxation roll 20b. In the longitudinal direction, the shrinkage is adjusted by means of the difference between the circumferential velocity w₁ of the first relaxation roll 20a and the circumferential velocity w₂ of the second relaxation roll 20b. The second relaxation roll 20b is used for cooling the plastic film 5. The operation of the relaxation unit 20 may be adjusted by means of the control unit 23.

The relaxation apparatus may also be a set of rolls comprising more than two, e.g. ten or even more, rolls. In this case the temperatures of the rolls are selected in such a manner that the temperature increases in the direction of the line and the velocity differences of successive rolls are reduced gradually.

FIGS. 8a and 8b illustrate the effect of relaxation on the form of the bubbles 24. FIG. 8a shows a bubble 24 in a situation where the film has not been substantially relaxed. In FIG. 8b, for its part, the film is relaxed 20% both in the longitudinal direction and in the cross direction. In the film which has not been relaxed the radius of the round bubble 24 is R and in the relaxed film, respectively, the radius of the bubble 24 is 0,8 R. In the non-relaxed film the height of the bubble 24 is h₁. In the relaxed film the height of the bubble 24 is h₂. The volume of the bubble 24 in the non-relaxed film is

V₁=k·h₁·π·R²

and the volume of the bubble 20 of the relaxed film, respectively, is

V₂=k·h₂·π·(0,8R)²,

wherein k is a shape constant.

Since the amount of gas or air inside the bubble 24 remains constant, the volume of the bubble 24 remains constant, i.e.

V₁=V₂

i.e.

k·h₁·π·R²=k·h₂·π·0.64·R²,

which gives

h₁=h₂·0,64,

which, for its part, gives

h₂=1,5625·h₁.

Thus, the height of the bubble 24 increases 56% when the plastic film is relaxed 20% both in the longitudinal direction and in the cross direction. As the height of the bubbles 24 increases, the thickness of the film 5 increases correspondingly. The shape constant k may be assumed to be constant, because the shape of the bubbles 24 does not change essentially. For the sake of clarity, in respect of their width the bubbles 24 in FIGS. 8a and 8b are shown as higher than in reality.

The plastic film 5 may be used for several different purposes in a manner known per se. At least one surface of the plastic film 5 can be provided with an electrically conductive coating, for instance, in which case the solution can be used e.g. as a microphone or loudspeaker in several acoustic applications, including sound attenuation. The plastic film 5 may also be provided with a permanent electric charge using e.g. the DC corona charge method.

The drawings and the related description are only intended to illustrate the inventive concept. The details of the invention may vary within the scope of the claims. Thus the orientation directions of the plastic film 5 and the order of orientations in different directions may vary. The simplest way to make a plastic film of the invention is to orientate the plastic film in the machine direction first and thereafter in the direction transverse to the machine direction.

Instead of or in addition to the above, the cooling device may also be implemented in such a manner that the cooling roll is dry and cooling medium circulation occurs inside it, or the cooling device may be some other cooling device solution known per se. To increase the foaming degree and reduce the density, gas may be supplied to the cavitation bubbles. Gas supply may be performed during the orientation or after it, for example. Gas supply may be performed, for example, between the longitudinal orientation and the cross-direction orientation. Furthermore, the plastic film need not necessarily be produced in a continuous production line but after the extrusion and the cooling, the plastic film preform may be stored temporarily. In this case the orientation of the plastic film by stretching does not occur until after the temporary storing. Hence, the extrusion and cooling of the plastic film may be performed in a place entirely different from that of the orientation of the plastic film. By means of temporary storing, the produced plastic film billets are provided with maximum crystallinity. The plastic film billet may also be treated thermally, i.e. heated and cooled alternately to improve the crystallinity. This thermal treatment may also be implemented in a continuous process, which is a process where the plastic film billet is not stored temporarily. Furthermore, e.g. the relaxation unit may be a separate apparatus and a treatment process, in which the already wound and orientated film may be treated in the above manner.

1. A method for producing a plastic film, the method comprising extruding a plastic film, cooling the plastic film, mixing material into the plastic of the plastic film before the extrusion, the material causing cavitation bubbles in the plastic film to be stretched, and orientating the plastic film by stretching after the cooling, characterized in that
after the extrusion the plastic film is cooled slowly below the crystallization point.

2. A method as claimed in claim 1, characterized by
relaxing the plastic film after the orientation at least 10% in both directions so that simultaneously the diameter of the cavitation bubbles is reduced and the height thereof is increased.

3. A method as claimed in claim 1, characterized by
cooling the plastic film so that the plastic has time to crystallize before the next process stage where the plastic film is orientated at a temperature lower than the melting point.

4. A method as claimed in claim 1 characterized by
cooling the plastic film by a cooling device whose temperature is higher than 130° C. below the melting point of the plastic material.

5. A method as claimed in claim 1, characterized by
cooling the plastic film by a cooling device whose temperature is higher than 100° C. below the melting point of the plastic material.

6. A method as claimed in claim 1, characterized by
cooling the plastic film for at least 5 seconds.

7. A method as claimed in claim 1, characterized by
reducing the temperature of the plastic film less than 30° C. in one second during the cooling.

8. A method as claimed in claim 1, characterized by
orientating the plastic film by stretching it in the machine direction so that the orientation temperature is lower than 25° C. below the melting temperature of the plastic materials.

9. A method as claimed in claim 1, characterized by
stretching the plastic film in the cross direction so that the orientation temperature is lower than 15° C. below the melting temperature of the plastic material.

10. A method as claimed in claim 1, characterized by
the plastic being crystalline plastic.

11. A method as claimed in claim 1, characterized by
performing the cooling at normal air pressure.

12. A method as claimed in claim 1, characterized by
storing the extruded and cooled plastic film temporarily before the orientation.

13. An apparatus for producing a plastic film, the apparatus comprising an extruder, a cooling device and at least one orientation device for orientating the extruded film, characterized in that
the apparatus comprises a control unit arranged to control the cooling device in such a manner that after the extrusion the plastic film cools slowly below the crystallization point.

14. An apparatus as claimed in claim 13, characterized in that
the apparatus comprises a relaxation unit arranged after the orientation device and that the control unit is arranged to control the relaxation unit to relax the plastic film at least 10% in both directions.

15. An apparatus as claimed in claim 13, characterized in that
the control unit is arranged to control the temperature of the cooling device to be higher than 130° C. below the melting point of the plastic material.

16. An apparatus as claimed in claim 13, characterized in that
the control unit is arranged to control the temperature of the cooling device to be higher than 100° C. below the melting point of the plastic material.

17. An apparatus as claimed in claim 13, characterized in that
the control unit is arranged to control the cooling device in such a manner that the temperature of the plastic film is reduced less than 30° C. in one second.

18. An apparatus as claimed in claim 13, characterized in that
the apparatus comprises a machine direction orientation device and that the control unit is arranged to control the orientation temperature of the machine direction orientation device to be lower than 25° C. below the melting temperature of the plastic material.

19. An apparatus as claimed in claim 13, characterized in that
the apparatus comprises a cross-direction orientation device and that the control unit is arranged to control the orientation temperature of the cross-direction orientation device to be lower than 15° C. below the melting temperature of the plastic material.
